(19) United States
(12) Patent Application Publication
(10) Pub. No.: US 2022/0297674 A1
(43) Pub. Date: Sep. 22, 2022

(54) SURROUND VIEW LOCALIZATION OF A VEHICLE

(71) Applicant: DUS Operating, Inc., Auburn Hills, MI (US)

(72) Inventors: Sanjiv Valsan, Auburn Hills, MI (US); Robert John Hoffman, JR., Royal Oak, MI (US)

(21) Appl. No.: 17/205,712

(22) Filed: Mar. 18, 2021

(51) Int. Cl. B60W 30/06; B60W 60/00; B60W 40/105; G06K 9/00

(52) U.S. Cl. CPC B60W 30/06; B60W 60/001; B60W 40/105; G06K 9/00812; B60W 2420/42; B60W 2530/201; B60W 2520/14

(57) ABSTRACT

A system and method for calculating coordinates for localization of a vehicle include continuously receive optical data from an optical sensing system having one or more cameras, and detect one or more parking spots within the optical data. The system and method determine a first location of the vehicle relative to the one or more parking spots, and plan a first path from a first location to second location different from the first location. One or more vehicle positioning systems is engaged to move the vehicle from the first location to the second location, and the first path is adjusted in real time in response to the optical data as the vehicle moves between the first location and the second location. The one or more vehicle positioning systems is then to adjust movement of the vehicle along the first path once the first path has been adjusted.

### FIELD

The present disclosure is directed to a system and method of using surround view data to locate a vehicle.

### BRIEF DESCRIPTION

The statements in this section merely provide background information related to the present disclosure and may or may not constitute prior art.

Vehicle technologies such as free-ranging on grid navigation, as well as parking guidance and information systems, aid in the prevention of human error when drivers operate a vehicle. Such technologies have been used to improve navigation of roadways, and to augment the parking abilities of vehicle drivers while the drivers are present within the vehicle. For example, rear view camera systems and impact alert systems have been developed to assist the operator of the vehicle while parking to avoid collisions. In addition, autonomous parking systems have been developed that autonomously park the vehicle in a parking spot once the operator of the vehicle has positioned the vehicle in a predefined location proximate the parking spot.

While these systems are useful for their intended purpose, they require the operator of the vehicle to locate the parking spot and to drive the vehicle to the parking spot. Thus, there is a need in the art for improved vehicle technologies that utilize preexisting infrastructure to autonomously park a vehicle. Moreover, there is a need to implement automatic parking systems in vehicles that are optimized to locate the vehicle relative to parking spots, and to mimic human drivers by planning a path to a parking spot and parking the vehicle.

### SUMMARY

According to several aspects of the present disclosure a method for calculating coordinates for localization of a vehicle includes continuously receiving optical data from an optical sensing system having one or more cameras, and detecting one or more parking spots within the optical data. The method determines a first location of the vehicle relative to the one or more parking spots within the optical data, and plans a first path from a first location to second location different from the first location. The method further includes engaging one or more vehicle positioning systems to move the vehicle from the first location to the second location, and adjusting the first path in real time in response to the optical data as the vehicle moves between the first location and the second location. The method engages the one or more vehicle positioning systems to adjust movement of the vehicle along the first path once the first path has been adjusted.

In another aspect of the present disclosure planning a first path from a first location to a second location different from the first location further includes utilizing predetermined physical vehicle parameters stored in memory to determine a range of possible first path trajectories. Planning a first path further includes determining a subset of the one or more parking spots that the vehicle can reach based on the range of possible first path trajectories, and selecting one of the subset of the one or more parking spots as the second location.

In yet another aspect of the present disclosure utilizing predetermined physical vehicle parameters further includes utilizing predetermined vehicle physical parameters and predetermined vehicle yaw information to determine the range of possible first path trajectories. The predetermined vehicle physical parameters include a vehicle width, a vehicle length, a predetermined range of vehicle turning angles, and a predetermined point location on the vehicle.

In yet another aspect of the present disclosure utilizing predetermined vehicle physical parameters further includes selecting the predetermined point location on the vehicle to be a center of a rear axle of the vehicle.

In yet another aspect of the present disclosure engaging one or more vehicle positioning systems to move the vehicle from the first location to the second location further includes calculating a first plurality of throttle system, braking system, transmission system, and steering system inputs to move the vehicle from the first location to the second location along the first path. Engaging the one or more vehicle positioning systems further includes selectively engaging the throttle system, the braking system, the transmission system, and the steering system of the vehicle to carry out the first plurality of throttle system, braking system, transmission system, and steering system inputs.

In yet another aspect of the present disclosure adjusting the first path in real time further includes utilizing one or more sensors to determine a current location of the vehicle relative to the first path. Adjusting the first path further includes utilizing the one or more sensors to determine a speed of the vehicle, an acceleration of the vehicle, and a yaw angle of the vehicle, and performing real time adjustments to the speed of the vehicle and the yaw angle of the vehicle and causing the vehicle to move along the first path between the first location and the second location.

In yet another aspect of the present disclosure utilizing one or more sensors to determine a current location of the vehicle relative to the first path further includes utilizing one or more sensors mounted to the vehicle, the one or more sensors detecting information comprising: optical information, vehicle yaw rate information, and vehicle acceleration information.

In yet another aspect of the present disclosure adjusting the first path in real time further includes calculating a second plurality of throttle system, braking system, transmission system, and steering system inputs to move the vehicle from the first location to the second location along the first path. Adjusting the first path further includes selectively engaging the throttle system, the braking system, the transmission system, and the steering system of the vehicle to carry out the second plurality of throttle system, braking system, transmission system, and steering system inputs.

In yet another aspect of the present disclosure adjusting the first path in real time further includes calculating the second plurality of throttle system, braking system, transmission system, and steering system inputs at predetermined time steps while the vehicle is moving from the first location to the second location. Adjusting the first path further includes selectively engaging the throttle system, the braking system, the transmission system, and the steering system at each of the predetermined time steps. A path efficiency of the first path is determined at a plurality of periodic time steps based on a current vehicle position and orientation along the first path. Adjusting the first path further includes generating a first confidence value for the first path. The first confidence value increases as the vehicle moves closer to the second location along the first path. Adjusting the first path further includes in real time, selectively determining a second path different from the first path based on the path efficiency at each of the plurality of periodic time steps. A second confidence value is generated for the second path. The second confidence value increases as the vehicle moves closer to the second location along the second path. The second path is determined when the path efficiency of the first path falls below a predetermined threshold efficiency value causing the first confidence value to fall below a predetermined threshold confidence value. The second path terminates at a second of the one or more of the parking spots within a detection range of the optical sensing system.

In yet another aspect of the present disclosure predicting a position of the vehicle relative to the second location further includes continuously tracking a current position of the vehicle relative to the second location, and continuously predicting a position of the vehicle relative to the second location based on a current operating state of the vehicle positioning systems. Predicting a position further includes periodically adjusting the first path in response to the optical data as the vehicle moves between the first location and the second location.

In yet another aspect of the present disclosure a method for calculating coordinates for localization of a vehicle includes continuously receiving optical data from an optical sensing system having one or more cameras. The method further includes detecting one or more parking spots within the optical data, and determining a first location of the vehicle relative to the one or more parking spots within the optical data. The first location of the vehicle is defined by a predetermined set of physical vehicle parameters stored in memory and including a predetermined point location on the vehicle. The method further includes utilizing the predetermined physical vehicle parameters to determine a range of possible first path trajectories, and determining a subset of the one or more parking spots that the vehicle can reach based on the range of possible first path trajectories. The method further includes selecting one of the subset of the one or more parking spots as the second location, and planning a first path from a first location to second location different from the first location. The method further includes engaging one or more vehicle positioning systems to move the vehicle from the first location to the second location, and adjusting the first path in real time in response to the optical data as the vehicle moves between the first location and the second location. The method further includes engaging the one or more vehicle positioning systems to adjust movement of the vehicle along the first path once the first path has been adjusted.

In yet another aspect of the present disclosure determining a first location of the vehicle relative to the one or more parking spots within the optical data further includes utilizing predetermined vehicle physical parameters and predetermined vehicle yaw information to determine the range of possible first path trajectories. The predetermined vehicle physical parameters include a vehicle width, a vehicle length, a predetermined range of vehicle turning angles, and the predetermined point location, wherein the predetermined point location is a center of the rear axle of the vehicle.

In yet another aspect of the present disclosure engaging one or more vehicle positioning systems to move the vehicle from the first location to the second location further includes calculating a first plurality of throttle system, braking system, transmission system, and steering system inputs to move the vehicle from the first location to the second location along the first path. Engaging the one or more vehicle positioning systems further includes selectively engaging the throttle system, the braking system, the transmission system, and the steering system of the vehicle to carry out the first plurality of throttle system, braking system, transmission system, and steering system inputs.

In yet another aspect of the present disclosure adjusting the first path in real time further includes utilizing one or more sensors to determine a current location of the vehicle relative to the first path, and utilizing the one or more sensors to determine a speed of the vehicle, and a yaw angle of the vehicle. Adjusting the first path further includes performing real time adjustments to the speed of the vehicle and the yaw angle of the vehicle and causing the vehicle to move along the first path between the first location and the second location.

In yet another aspect of the present disclosure utilizing one or more sensors to determine a current location of the vehicle relative to the first path further includes utilizing one or more sensors mounted to the vehicle. The one or more sensors detect information comprising: optical information, vehicle yaw rate information, and vehicle acceleration information.

In yet another aspect of the present disclosure adjusting the first path in real time further includes calculating a second plurality of throttle system, braking system, transmission system, and steering system inputs to move the vehicle from the first location to the second location along the first path. Adjusting the first path further includes selectively engaging the throttle system, the braking system, the transmission system, and the steering system of the vehicle to carry out the second plurality of throttle system, braking system, transmission system, and steering system inputs.

In yet another aspect of the present disclosure adjusting the first path in real time further includes in real time, calculating the second plurality of throttle system, braking system, transmission system, and steering system inputs at predetermined time steps while the vehicle is moving from the first location to the second location. Adjusting the first path further includes selectively engaging the throttle system, the braking system, the transmission system, and the steering system at each of the predetermined time steps.

In yet another aspect of the present disclosure predicting a position of the vehicle relative to the second location further includes continuously tracking a current position of the vehicle relative to the second location with an optical sensing system. Predicting a position of the vehicle further includes continuously predicting a position of the vehicle relative to the second location based on a current operating state of the vehicle positioning systems, and periodically adjusting the first path in response to the optical data as the vehicle moves between the first location and the second location.

In yet another aspect of the present disclosure the method further includes determining a path efficiency of the first path at a plurality of periodic time steps based on a current vehicle position and orientation along the first path. In real time, the method selectively determines a second path different from the first path based on the path efficiency at each of the plurality of periodic time steps. The method generates a first confidence value for the first path. The first confidence value increases as the vehicle moves closer to the second location along the first path, wherein the second location is one or more of the parking spots within the ground truth data. The second path is determined when the path efficiency falls below a predetermined threshold value, and the second path terminates at a second of the one or more of the parking spots within a detection range of the optical sensing system when the path efficiency falls below the predetermined threshold confidence value.

In yet another aspect of the present disclosure a system for calculating coordinates for localization of a vehicle includes a vehicle having a throttle system, a braking system, a transmission system, and a steering system; each of the throttle system, braking system, transmission system, and steering system providing directional control of the vehicle. The system further includes a control module disposed within the host vehicle and having a processor, a memory, and one or more input/output (I/O) ports. The I/O ports receive input data from one or more sensors and actuators, and the I/O ports transmit output data to one or more actuators of the vehicle. The processor executing programmatic control logic stored within the memory. The programmatic control logic includes a first control logic continuously receiving optical data from an optical sensing system having one or more cameras. A second control logic detects one or more parking spots within the optical data. A third control logic determines a first location of the vehicle relative to the one or more parking spots within the optical data, the first location of the vehicle defined by a predetermined set of physical vehicle parameters stored in memory and including a predetermined point location on the vehicle. A fourth control logic utilizes the predetermined physical vehicle parameters to determine a range of possible first path trajectories. A fifth control logic determines a subset of the one or more parking spots that the vehicle can reach based on the range of possible first path trajectories. A sixth control logic selects one of the subset of the one or more parking spots as a second location. A seventh control logic plans a first path from a first location to the second location different from the first location. An eighth control logic engages one or more vehicle positioning systems to move the vehicle from the first location to the second location. A ninth control logic adjusts the first path in real time in response to the optical data as the vehicle moves between the first location and the second location. A tenth control logic engages the one or more vehicle positioning systems to adjust movement of the vehicle along the first path once the first path has been adjusted.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic illustration of a system for surround view localization of a vehicle according to an embodiment of the present disclosure;

FIG. 2 is an illustration of a system for surround view localization of a vehicle including a coordinate system according to an embodiment of the present disclosure;

FIG. 3 is an illustration of a system for surround view localization of a vehicle including a plurality of parking spot coordinates within a coordinate system according to an embodiment of the present disclosure;

FIG. 4 is another illustration of a system for surround view localization of a vehicle including a plurality of parking spot coordinates and other vehicles within a coordinate system according to an embodiment of the present disclosure; and

FIG. 5 is a flow chart of a method for surround view localization of a vehicle according to an embodiment of the present disclosure.

### DETAILED DESCRIPTION

The following description is merely exemplary in nature and is not intended to limit the present disclosure, application or uses.

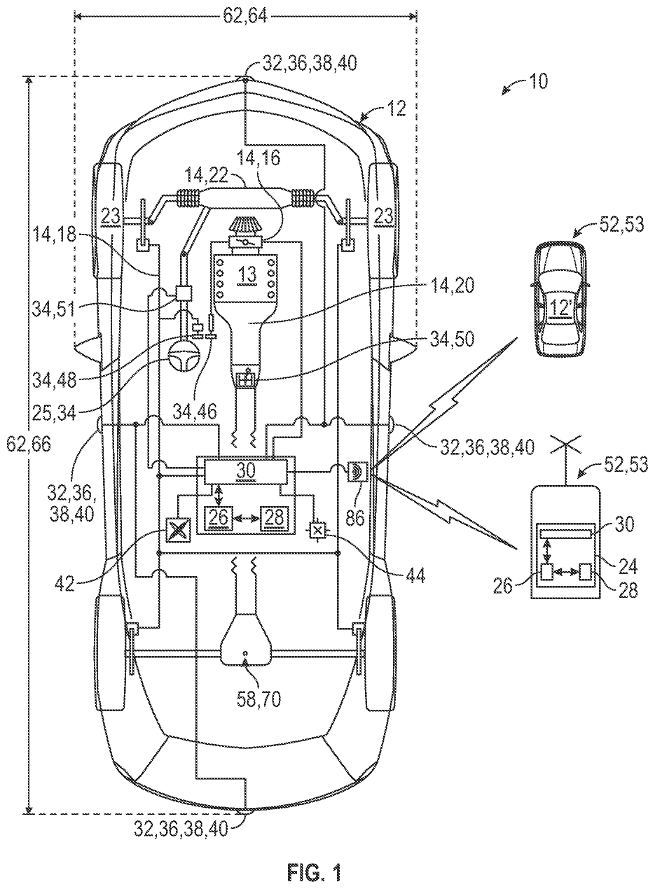

With reference to FIG. 1, a system for localizing a vehicle according to the principles of the present disclosure is shown and indicated generally by reference number 10. The system 10 operates on a vehicle 12. The vehicle 12 is illustrated as a passenger vehicle, however the vehicle 12 may be a truck, sport utility vehicle, van, motor home, or any other type of road vehicle, water vehicle, or air vehicle without departing from the scope or intent of the present disclosure. The vehicle 12 is equipped with one or more positioning systems 14. In several examples, the positioning systems 14 include a throttle system 16, a braking system 18, a transmission system 20, and a steering system 22. A vehicle operator uses the throttle system 16 to control a rate of acceleration of the vehicle 12. In several aspects, the throttle system 16 controls a torque output of propulsion devices 13 that motivate the vehicle 12. The braking system 18 controls a rate of deceleration of the vehicle 12. In examples, the braking system 18 may operate or control a quantity of braking pressure applied to the disc or drum brakes of an exemplary vehicle 12. The transmission system 20 controls directional movement of the vehicle 12. In some examples, the transmission may be a geared transmission such as a manual transmission, a dual clutch transmission, a continuously variable transmission, an automatic transmission, any combination of these transmission types, or the like. Similarly, the transmission system 20 may control a direction of rotation of electric motors or motivators disposed in and providing propulsion to the vehicle 12. The steering system 22 controls a yaw rate of the vehicle 12 and may include steerable wheels 23, in combination with a steering apparatus such as a steering wheel 25, a tiller, or any of a variety of aeronautical control surfaces providing yaw control to an aircraft.

The vehicle 12 is equipped with one or more control modules 24. Each control module 24 is a non-generalized electronic control device having a preprogrammed digital computer or processor 26, memory or non-transitory computer readable medium 28 used to store data such as control logic, instructions, image data, lookup tables, and the like, and a plurality of input/output (I/O) peripherals or ports 30. The processor 26 is configured to execute the control logic or instructions. The control logic or instructions include any type of program code, including source code, object code, and executable code. The control logic also includes software programs configured to perform a specific function or set of functions. The control logic may include one or more computer programs, software components, sets of instructions, procedures, functions, objects, classes, instances, related data, or a portion thereof adapted for implementation in a suitable computer readable program code. The control logic may be stored within the memory 28 or in additional or separate memory.

The control modules 24 may have additional processors 26 or additional integrated circuits in communication with the processors 26, such as perception logic circuits for analyzing visual data, or dedicated vehicle-to-vehicle (V2V) or vehicle-to-infrastructure (V2I) circuits. Alternatively, the functions of the control module 24 may be distributed across a variety of sub-systems. The memory 28 includes media where data can be permanently stored and/or media where data can be stored and later overwritten, such as a rewritable optical disc or erasable memory device. In further examples, the memory 28 may include any of a variety of different storage media, such as flash memory, an embedded multimedia card (EMMC) flash memory, a random access memory (RAM), or the like. The I/O ports 30 receive input data from one or more sensors 32 and actuators 34 of the vehicle 12.

The sensors 32 include an optical sensing system 35 having sensors such as cameras 36, ultrasonic sensors, light detection and ranging (LiDAR) units 38, and radio detection and ranging (RADAR) units 40. The sensors 32 of the optical sensing system 35 are shown in four distinct locations in FIG. 1, however, it should be appreciated that the sensors 32 may be located at any of a variety of other locations on or off the vehicle 12 without departing from the scope or intent of the present disclosure. The sensors 32 also include movement sensors such as gyroscopic sensors 42, accelerometers 44, and the like. The actuators 34 should be understood to include electronic, hydraulic, and pneumatic devices capable of altering the movement of the vehicle 12. In some examples, the actuators 34 include a throttle actuator 46 of the throttle system 16 operable to alter a quantity of torque generated by the propulsion device of the vehicle 12. In another example, the actuators 34 include a brake actuator 48 of the braking system 18. The brake actuator 48 is operable to alter a quantity of deceleration applied by the braking system 18 of the vehicle 12. In further examples, the actuators 34 include a transmission ratio selector 50 of the transmission system 20, and a steering actuator 51 of the steering system 22. The transmission ratio selector 50 is operable to alter a direction and/or rate of motion of the vehicle 12. The steering actuator 51 adjusts a yaw rate of the vehicle 12.

The control module 24 communicates electronically, pneumatically, hydraulically, or the like, with a variety of on-board systems, such as the throttle system 16, the braking system 18, the transmission system 20, and the steering system 22. In further examples, the control module 24 also communicates wirelessly with remote infrastructure 52 such as other vehicles 12′ or remote computing systems 53 of parking infrastructure in V2V or V2I systems

The processors 26 execute programmatic control logic stored within the memory 28 of the control modules 24 and operable to calculate coordinates for localization of the vehicle 12. In a control logic, the processor 26 continuously receive optical data from the sensors 34 of the optical sensing system 35 having one or more cameras 36. The processor 26 executes another control logic that detects ground truth data within the optical data. The ground truth data may include any of a variety of data types, including, but not limited to lane lines or markings, curbs, parking spot lines, potholes, lamp posts, street signs, pedestrians, animals, bicyclists, motorcyclists, other vehicles, or the like. In an example, the processor 26 utilizes the optical sensing system 35 to optically scan a predetermined area A around the vehicle 12. The processor 26 detects one or more parking spots 54 within the ground truth data. To determine the locations of the one or more parking spots 54, the processor 26 generate a coordinate system 56 utilizing a predetermined point location 58 on the vehicle 12 as the origin of the coordinate system 56. The processor or processor 26 then determines coordinates to predetermined locations of each of the one or more parking spots 54. In an example, the processor 26 determines the coordinates of four or more points P0, P1, P2, P3 within the ground truth data. The four or more points P0, P1, P2, P3 define corners of each of the one or more parking spots 54. The ground truth data, including the coordinate system 56 and the coordinates for each of the one or more parking spots 54 are stored within the memory 28.

The processor 26 then executes a control logic that determines a first location 60 of the vehicle 12 relative to the one or more parking spots 54 within the optical data. Specifically, the first location of the vehicle 12 is determined or defined in part by a predetermined set of physical vehicle parameters 62 or characteristics. The physical vehicle parameters 62 are stored in memory 28 and include a vehicle width 64, a vehicle length 66, a predetermined range of vehicle turning angles 68, and the predetermined point location 58 on the vehicle. Since the vehicle 12 may be any of the wide variety of vehicle types described above, it should be appreciated that the vehicle width 64, length 66, turning angles 68, and the predetermined point location 58 may vary substantially from application to application. Each of the physical vehicle parameters 62 defines not only the size and shape of the vehicle 12, but also certain mobility characteristics of the vehicle 12. In an example of a car, the predetermined point location 58 is selected to be the center of the rear axle 70.

The processor 26 executes a control logic that includes a path planner. The path planner calculates utilizes the physical vehicle parameters 62 to determine a range of possible first path trajectories 72. The first path trajectories 72 are a set of paths to each of the one or more parking spots 54 within the optical data. In a control logic, the processor 26 determines a subset 74 of the one or more parking spots 54 that the vehicle 12 can reach most efficiently. More specifically, the processor 26 compares the physical vehicle parameters 62 to determine maneuvering capabilities of the vehicle 12. The maneuvering capabilities are then compared to each of the set of first path trajectories 72 to determine whether vehicle 12 is capable of maneuvering along each of the first path trajectories 72. The processor 26 then winnows down the set of first path trajectories 72 to determine the subset 74 of the one or more parking spots 54 that the vehicle 12 is capable of reaching. The processor 26 utilizes the path planner to calculate a first path 76 from the first location 60 to a second location 78 different from the first location 60. In several aspects, the processor 26 defines one of the one or more parking spots 54 as the second location 78 based on the stored ground truth data, and specifically, based on the locations of the one or more parking spots 54.

The processor 26 executes a control logic that moves the vehicle 12 from the first location 60 to the second location 78 along the first path 76. That is, the processor 26 commands or engages the vehicle positioning systems 14, including the throttle system 16, braking system 18, transmission system 20, and steering system 22 to move the vehicle 12 from the first location 60 to the second location 78. The processor 26 commands or engages the vehicle positioning systems 14 by first calculating a plurality of throttle system 16, braking system 18, transmission system 20, and steering system 22 inputs to move the vehicle 12 from the first location 60 to the second location 78 along the first path 26. Subsequently, the processor 26 selectively engages the throttle system 16, braking system 18, transmission system 20, and steering system 22 of the vehicle 12 to carry out the plurality of throttle, braking, transmission, and steering system 16, 18, 20, 22 inputs. As the vehicle 12 moves, the control module 24 continuously retrieves data from the sensors 32 and actuators 34. The processor 26 executes control logic to monitor the location of the vehicle along the first path 76. The control module 24 continuously tracks a current position of the second location 78 relative to the vehicle 12 as the vehicle 12 moves along the first path 76.

Utilizing one or more of the sensors 32, the processor 26 tracks determines a current location of the vehicle 12 relative to the first path 76. The processor 26 utilizes the one or more sensors 32 to determine current operating conditions of the vehicle 12. For example, the sensors 32 detect information such as optical information, vehicle yaw rate information, and vehicle acceleration information. From the optical information, yaw rate information, and vehicle acceleration, the processor 26 determines at least a speed, an acceleration, and a yaw angle of the vehicle 12. Additionally, the processor 26 tracks current positions of each of the second location 78 and the vehicle 12 within the optical data.

In order to ensure that the vehicle 12 will continue to move towards the second location 78 and along the first path 76, the processor 26 performs real time adjustments to the speed and yaw angle of the vehicle. The processor 26 executes control logic to determine a current position of the vehicle 12 within the optical data, and to determine a current operating state of the vehicle positioning systems 14. Based on the current operating state of the vehicle positioning systems 14 and the current position of the vehicle 12, the processor 26 extrapolates or predicts the position of the vehicle 12 at a subsequent predetermined point in time. In several aspects, the processor 26 periodically extrapolates the position of the vehicle 12 as the vehicle moves towards the second location 78. In some examples, the periodic extrapolations are carried out on a predefined schedule of time steps 79; for example between once every half second and once every five seconds. It should be appreciated that the time steps 79 may be separated by consistent intervals of time, or by inconsistent intervals of time. That is, the time steps 79 may be based in part on a velocity of the vehicle 12, such that the faster the vehicle is moving 12, the shorter the intervals of time between time steps 79 might be.

The processor executes a control logic that periodically or continuously predicts a position of the vehicle 12 relative to the second location 78. Specifically, the processor 26 utilizes the physical vehicle parameters 62 as well as live data such as current velocity, yaw rate, and longitudinal, lateral, and rotational acceleration to determine the relative location of the second location 78 to the present position of the vehicle 12. Based on the live data, and the predicted position of the vehicle 12 and on current operating conditions, the processor 26 determines a future operating state of the vehicle positioning systems 14.

The future operating state is selected to ensure that the vehicle 12 continues to move along the first path 76. In several aspects, the processor 26 extrapolates the position of the vehicle 12 at a subsequent time step 79″ based on the current operating state of the vehicle positioning systems 14, the current position of the vehicle 12 within the optical data, and the predetermined amount of time between the current time step 79′ and the subsequent time step 79″. Additionally, the processor 26 extrapolates the position of the vehicle 12 at a subsequent time step 79″ based on a second predetermined amount of time that the future operating state will be engaged.

In several aspects, an actual rate of movement of the vehicle 12 may vary from a desired rate of movement. Accordingly, the processor 26 executes control logic to periodically adjust the first path 76 in real time in response to the ground truth data within the optical data as the vehicle 12 moves between the first location 60 to the second location 78. In an example the actual rate of movement of the vehicle 12 causes the vehicle 12 to depart from the first path 76. In some examples, the processor 26 continuously monitors the position and movement rates of the vehicle 12 as described above and executes a control logic that causes the vehicle 12 to begin to travel down a second path 80. That is, upon determining that the vehicle 12 is departing from the first path 76, the processor 26 calculates a second plurality of throttle system 16, braking system 18, transmission system 20, and steering system 22 inputs at each predetermined time step while the vehicle 12 is moving along the first path 76. The second plurality of throttle, braking, transmission, and steering system 16, 18, 20, 22 inputs are calculated to move the vehicle 12 from the first location 60 to the second location 78 along the first path 76. The processor 26 then selectively engages one or more of the throttle, braking, transmission, and steering systems 16, 18, 20, 22 to carry out the second plurality of throttle, braking, transmission, and steering system 16, 18, 20, 22 inputs.

Specifically, the path planner determines a first path efficiency of the first path 76 at each of the periodic time steps 79. The first path efficiency is based on a current position of the vehicle 12, the orientation of the vehicle 12 along the first path 76, and the physical vehicle parameters 62. In some examples, the first path efficiency falls below a predefined threshold value. When the first path efficiency falls below the predefined threshold value, in real time the processor 26 selectively determines a second path 80 different from the first path 76. The processor 26 determines the second path 80 based on the first path efficiency at each of the plurality of periodic time steps 79. The second path 80 terminates at a second parking spot 82 of the one or more of the parking spots 54 within a detection range 84 of the optical sensing system 35 when the first path efficiency falls below a predetermined threshold path efficiency value. The processor 26 generates a first confidence value for the first path 76. Likewise, the processor 26 generates a second confidence value for the second path 80 where the first and second confidence values increase as the vehicle 12 moves closer to the second location 78 along either the first path 76 or the second path 80. When the path efficiency falls below the predetermined threshold path efficiency value, the first first and/or second confidence values also fall below the predetermined threshold confidence value. Once the first and/or second confidence value falls below the predetermined threshold confidence value, the processor 26 calculates a path different than the first path currently being used to navigate to the parking spot 54. It should be appreciated that while only “first” and “second” paths 76, 80, and associated path efficiency and confidence values have been discussed, that any number of paths, path efficiencies, and confidence values may be used to navigate the vehicle 12 to a second location 78.

In a further example, the optical sensing system 35 may be mounted in a location entirely remote from the vehicle 12. That is, the processor 26 may continuously receive optical data from an optical sensing system 35 having one or more cameras 36 mounted in a location separate from the vehicle 12, such as in a V2V or V2I system. In an arrangement where the optical sensing system 35 is mounted in a remote location from the vehicle 12, the optical sensing system 35 communicates wirelessly with the vehicle 12 via a wireless communication system 86. The wireless communication system 86 includes components disposed in or on the vehicle 12, such as a transceiver configured to wirelessly communicate with remote wireless hotspots using Wi-Fi protocols under IEEE 802.11x, or the like. The optical sensing system 35 otherwise operates substantially similarly to what has been described hereinabove. However, when the one or more cameras 36 are disposed on infrastructure that is remote from the vehicle 12, the one or more cameras 36 may communicate optical data to one or more vehicles 12 within a predefined area, such as a parking lot. Accordingly, the one or more cameras 36 provide optical information to a plurality of vehicles 12 performing automatic parking functions utilizing path planners.

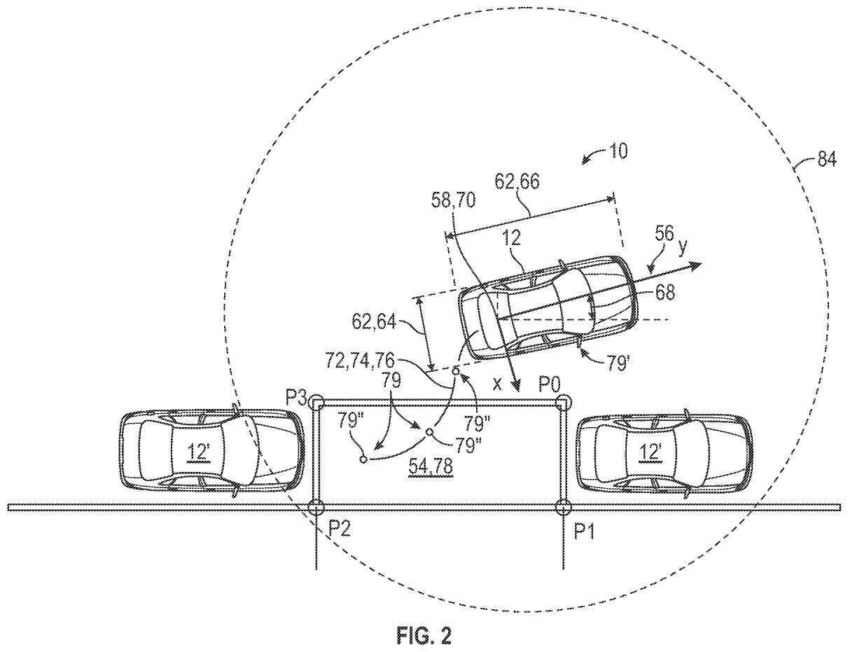

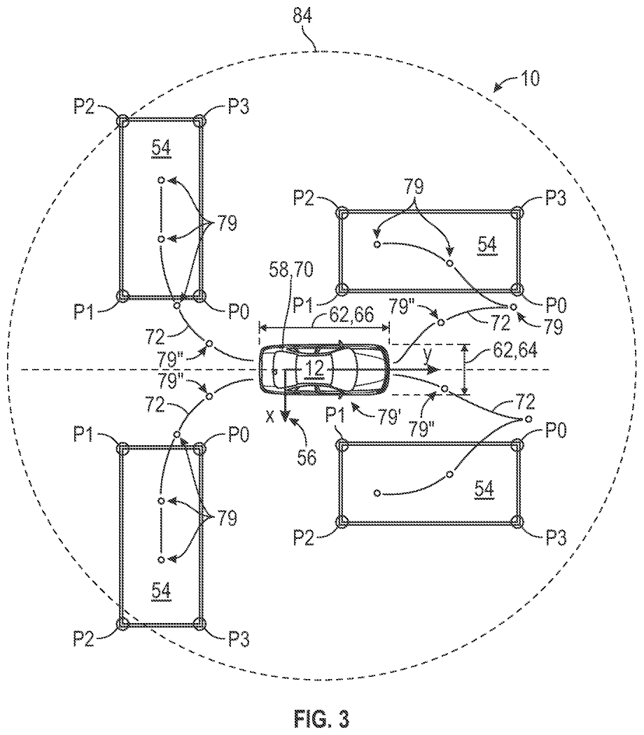

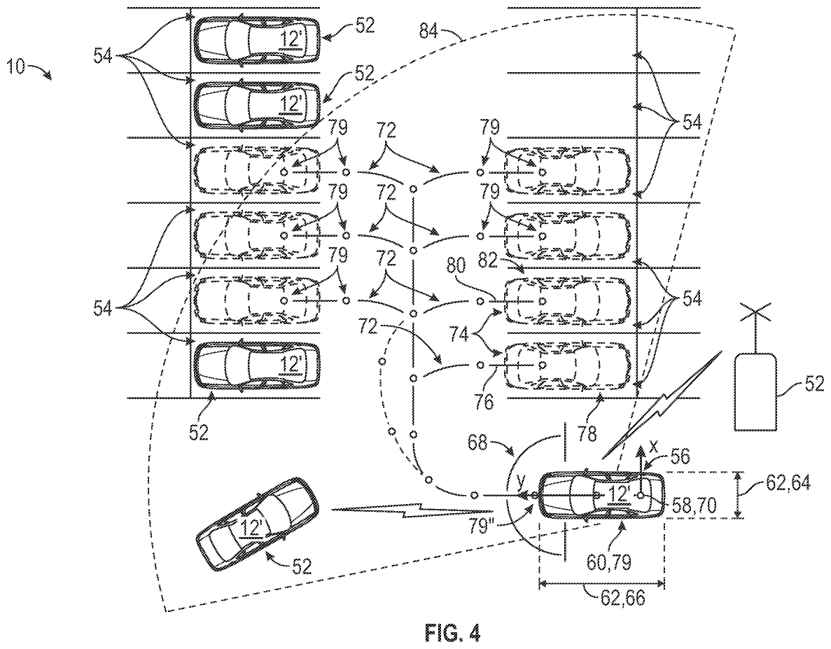

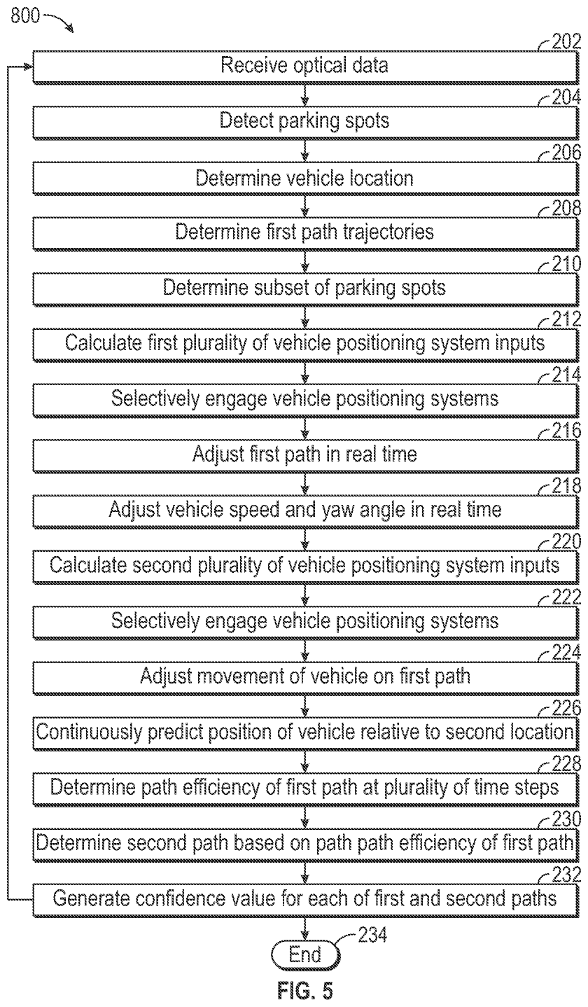

Turning now to FIG. 5, and with continuing reference to FIGS. 1-4, a method for calculating coordinates for localization of a vehicle 12 is shown and generally indicated by reference number 200. The method 200 begins at block 202 where the processor 26 of the vehicle 12 continuously receives optical data from the optical sensing system 35 having one or more cameras 36. At block 204 the processor 26 detects one or more parking spots 54 within the optical data. At block 206, the processor 26 determines the first location 60 of the vehicle 12 relative to the one or more parking spots 54. The first location 60 of the vehicle 12 is defined by the predetermined physical vehicle parameters 62, such as the vehicle width 64, vehicle length 66, and the predetermined point location 70 on the vehicle 12. Each of the predetermined vehicle physical parameters 62 are stored in memory 28, and may be application specific. Additional physical vehicle parameters 62 may include turning radii, or turning angles 68 that the vehicle 12 is capable of achieving. At block 208, utilizing the predetermined vehicle physical parameters 62, as well as predetermined yaw information, the processor 26 determines a range of possible first path trajectories 72.

At block 210, the processor 26 determines a subset 74 of the one or more parking spots 54 that the vehicle 12 is capable of reaching based on the range of possible first path trajectories 72. At block 212, the processor 26 selects one of the subset 74 of the one or more parking spots 54 as the second location 78, and utilizes a path planner to plan a first path 76 from the first location 60 to the second location 78.

At block 212, the processor 26 engages one or more vehicle positioning systems 14 to move the vehicle 12 from the first location 60 to the second location 78 along the first path 76. More specifically, the processor 26 calculates a first plurality of throttle, braking, transmission, and steering system 16, 18, 20, 22 inputs to move the vehicle from the first location 60 to the second location 78 along the first path 76.

At block 214, the processor 26 selectively engages the throttle, braking, transmission, and steering systems 16, 18, 20, 22 of the vehicle 12 to carry out the first plurality of throttle, braking, transmission, and steering system 16, 18, 20, 22 inputs.

At block 216, the processor 26 adjusts the first path 76 in real time in response to the optical data as the vehicle 12 moves between the first location 60 and the second location 78. The processor 26 adjusts the first path 76 by utilizing one or more sensors 32 to determine a current location of the vehicle 12 relative to the first path 76. Specifically, the processor 26 utilizes the one or more sensors 32 mounted to the vehicle 12 to determine a speed of the vehicle 12, a yaw angle of the vehicle, an acceleration of the vehicle 12, and the like.

At block 218, the processor 26 utilizes the data from the one or more sensors 32 to perform real time adjustments to the speed of the vehicle 12 and the yaw angle of the vehicle 12 and causing the vehicle 12 to move along the first path 76 between the first location 60 and the second location 78.

At block 220, the processor 26 engages the vehicle positioning systems 14 to move the vehicle 12 from the first location 60 to the second location 78 along the first path 76. More specifically, the processor 26 calculates a second plurality of throttle, braking, transmission, and steering system 16, 18, 20, 22 inputs to move the vehicle 12 from the first location 60 to the second location 78 along the first path 76. More generally the processor 26 calculates the second plurality of throttle system, braking system, transmission system, and steering system inputs in real-time at predetermined time steps 79 while the vehicle 12 is moving from the first location 60 to the second location 78

At block 222, the processor 26 then selectively engages the throttle, braking, transmission, and steering system 16, 18, 20, 22 of the vehicle 12 to carry out the second plurality of throttle, braking, transmission, and steering system 16, 18, 20, 22 inputs. More generally, the processor 26 selectively engages the throttle, braking, transmission, and steering system 16, 18, 20, 22 at each of the predetermined time steps 79 to carry out adjustments to the vehicle's 12 movement along the first path 76.

At block 224, the processor 26 engages one or more of the vehicle positioning systems 14 to adjust movement of the vehicle 12 along the first path 76 once the first path 76 has been adjusted. To do so, the processor 26 predicts a position of the vehicle 12 relative to the second location 78. To predict the position of the vehicle 12 relative to the second location 78, the processor 26 continuously tracks a current position of the vehicle 12 relative to the second location 78 with the optical sensing system 35.

At block 226, the processor 26 continuously predicts a position of the vehicle 12 relative to the second location 78 based on a current operating state of the vehicle positioning systems 14, and the first path 76. The processor 26 then periodically adjusts the first path 76 in response to the optical data as the vehicle 12 moves between the first location 60 and the second location 78.

At block 228, the processor 26 determines a path efficiency of the first path at a plurality of periodic time steps 79 based on a current vehicle position and orientation along the first path.

At block 230, in real time the processor 26 determines a second path 80 different from the first path 76 based on the path efficiency of the first path 76 at each of the plurality of periodic time steps 79. The second path 80 is determined when the path efficiency falls below a predetermined threshold value.

At block 232, the processor 26 generates a first confidence value for the first path 76, and a second confidence value for the second path 80. Each of the first and second confidence values increase as the vehicle 12 moves closer to the second location 78 along the each of the first and second paths 76, 80. When the vehicle 12 is following the second path 80, the processor 26 assigns a second parking spot 82 within a detection range 84 of the optical sensing system 35 to be the second location 78.

At block 234, the method ends and returns to block 202 when an operator of the vehicle 12 engages automatic parking functions of the vehicle 12 again.

A system and method for surround view localization of a vehicle 12 of the present disclosure offers several advantages. These include ability to utilize preexisting infrastructure to autonomously park a vehicle. Moreover, the system and method of the present disclosure may be used to implement automatic parking systems in vehicles that are optimized to locate the vehicle relative to parking spots, and to mimic human drivers by planning a path to a parking spot and parking the vehicle.

The description of the present disclosure is merely exemplary in nature and variations that do not depart form the gist of the present disclosure are intended to be within the scope of the present disclosure. Such variations are not to be regarded as a departure from the spirit and scope of the present disclosure.

What is claimed is:

1. A method for calculating coordinates for localization of a vehicle, the method comprising:
continuously receiving optical data from an optical sensing system having one or more cameras;
detecting one or more parking spots within the optical data;
determining a first location of the vehicle relative to the one or more parking spots within the optical data;
planning a first path from a first location to second location different from the first location;
engaging one or more vehicle positioning systems to move the vehicle from the first location to the second location;
adjusting the first path in real time in response to the optical data as the vehicle moves between the first location and the second location; and
engaging the one or more vehicle positioning systems to adjust movement of the vehicle along the first path once the first path has been adjusted.

2. The method of claim 1 wherein planning a first path from a first location to a second location different from the first location further comprises:
utilizing predetermined physical vehicle parameters stored in memory to determine a range of possible first path trajectories;
determining a subset of the one or more parking spots that the vehicle can reach based on the range of possible first path trajectories; and
selecting one of the subset of the one or more parking spots as the second location.

3. The method of claim 2 wherein utilizing predetermined physical vehicle parameters further comprises:
utilizing predetermined vehicle physical parameters and predetermined vehicle yaw information to determine the range of possible first path trajectories, the predetermined vehicle physical parameters comprising:
a vehicle width;
a vehicle length;
a predetermined range of vehicle turning angles; and
a predetermined point location on the vehicle.

4. The method of claim 3 wherein utilizing predetermined vehicle physical parameters further comprises:
selecting the predetermined point location on the vehicle to be a center of a rear axle of the vehicle.

5. The method of claim 2 wherein engaging one or more vehicle positioning systems to move the vehicle from the first location to the second location further comprises:
calculating a first plurality of throttle system, braking system, transmission system, and steering system inputs to move the vehicle from the first location to the second location along the first path; and
selectively engaging the throttle system, the braking system, the transmission system, and the steering system of the vehicle to carry out the first plurality of throttle system, braking system, transmission system, and steering system inputs.

6. The method of claim 1 wherein adjusting the first path in real time further comprises:
utilizing one or more sensors to determine a current location of the vehicle relative to the first path;
utilizing the one or more sensors to determine a speed of the vehicle, an acceleration of the vehicle, and a yaw angle of the vehicle; and
performing real time adjustments to the speed of the vehicle and the yaw angle of the vehicle and causing the vehicle to move along the first path between the first location and the second location.

7. The method of claim 6 wherein utilizing one or more sensors to determine a current location of the vehicle relative to the first path further comprises:
utilizing one or more sensors mounted to the vehicle, the one or more sensors detecting information comprising: optical information, vehicle yaw rate information, and vehicle acceleration information.

8. The method of claim 6 wherein adjusting the first path in real time further comprises:
calculating a second plurality of throttle system, braking system, transmission system, and steering system inputs to move the vehicle from the first location to the second location along the first path; and
selectively engaging the throttle system, the braking system, the transmission system, and the steering system of the vehicle to carry out the second plurality of throttle system, braking system, transmission system, and steering system inputs.

9. The method of claim 6 wherein adjusting the first path in real time further comprises:
calculating the second plurality of throttle system, braking system, transmission system, and steering system inputs at predetermined time steps while the vehicle is moving from the first location to the second location;
selectively engaging the throttle system, the braking system, the transmission system, and the steering system at each of the predetermined time steps;
determining a path efficiency of the first path at a plurality of periodic time steps based on a current vehicle position and orientation along the first path;
generating a first confidence value for the first path, wherein the first confidence value increases as the vehicle moves closer to the second location along the first path,
in real time, selectively determining a second path different from the first path based on the path efficiency at each of the plurality of periodic time steps;
generating a second confidence value for the second path, wherein the second confidence value increases as the vehicle moves closer to the second location along the second path, wherein the second location is one or more of the parking spots within the ground truth data; and
wherein the second path is determined when the path efficiency falls below a predetermined threshold efficiency value causing the first confidence value to fall below a predetermined threshold confidence value, the second path terminates at a second of the one or more of the parking spots within a detection range of the optical sensing system.

10. The method of claim 1 further comprising:
predicting a position of the vehicle relative to the second location by:
continuously tracking a current position of the vehicle relative to the second location;
continuously predicting a position of the vehicle relative to the second location based on a current operating state of the vehicle positioning systems, the first path; and
periodically adjusting the first path in response to the optical data as the vehicle moves between the first location and the second location.

11. A method for calculating coordinates for localization of a vehicle, the method comprising:
continuously receiving optical data from an optical sensing system having one or more cameras;
detecting one or more parking spots within the optical data;
determining a first location of the vehicle relative to the one or more parking spots within the optical data, the first location of the vehicle defined by a predetermined set of physical vehicle parameters stored in memory and including a predetermined point location on the vehicle;
utilizing the predetermined physical vehicle parameters to determine a range of possible first path trajectories;
determining a subset of the one or more parking spots that the vehicle can reach based on the range of possible first path trajectories; and
selecting one of the subset of the one or more parking spots as the second location;
planning a first path from a first location to second location different from the first location;
engaging one or more vehicle positioning systems to move the vehicle from the first location to the second location;
adjusting the first path in real time in response to the optical data as the vehicle moves between the first location and the second location; and
engaging the one or more vehicle positioning systems to adjust movement of the vehicle along the first path once the first path has been adjusted.

12. The method of claim 11 wherein determining a first location of the vehicle relative to the one or more parking spots within the optical data further comprises:
utilizing predetermined vehicle physical parameters and predetermined vehicle yaw information to determine the range of possible first path trajectories, the predetermined vehicle physical parameters comprising:
a vehicle width;
a vehicle length;
a predetermined range of vehicle turning angles; and
the predetermined point location, wherein the predetermined point location is a center of the rear axle of the vehicle.

13. The method of claim 11 wherein engaging one or more vehicle positioning systems to move the vehicle from the first location to the second location further comprises:
calculating a first plurality of throttle system, braking system, transmission system, and steering system inputs to move the vehicle from the first location to the second location along the first path; and
selectively engaging the throttle system, the braking system, the transmission system, and the steering system of the vehicle to carry out the first plurality of throttle system, braking system, transmission system, and steering system inputs.

14. The method of claim 11 wherein adjusting the first path in real time further comprises:
utilizing one or more sensors to determine a current location of the vehicle relative to the first path;
utilizing the one or more sensors to determine a speed of the vehicle, and a yaw angle of the vehicle; and
performing real time adjustments to the speed of the vehicle and the yaw angle of the vehicle and causing the vehicle to move along the first path between the first location and the second location.

15. The method of claim 14 wherein utilizing one or more sensors to determine a current location of the vehicle relative to the path further comprises:
utilizing one or more sensors mounted to the vehicle, the one or more sensors detecting information comprising: optical information, vehicle yaw rate information, and vehicle acceleration information.

16. The method of claim 15 wherein adjusting the first path in real time further comprises:
calculating a second plurality of throttle system, braking system, transmission system, and steering system inputs to move the vehicle from the first location to the second location along the first path; and
selectively engaging the throttle system, the braking system, the transmission system, and the steering system of the vehicle to carry out the second plurality of throttle system, braking system, transmission system, and steering system inputs.

17. The method of claim 15 wherein adjusting the first path in real time further comprises:
in real time, calculating the second plurality of throttle system, braking system, transmission system, and steering system inputs at predetermined time steps while the vehicle is moving from the first location to the second location; and
selectively engaging the throttle system, the braking system, the transmission system, and the steering system at each of the predetermined time steps.

18. The method of claim 11 further comprising:
predicting a position of the vehicle relative to the second location by:
continuously tracking a current position of the vehicle relative to the second location with the optical sensing system;
continuously predicting a position of the vehicle relative to the second location based on a current operating state of the vehicle positioning systems, the first path; and
periodically adjusting the first path in response to the optical data as the vehicle moves between the first location and the second location.

19. The method of claim 11 further comprising:
determining a path efficiency of the first path at a plurality of periodic time steps based on a current vehicle position and orientation along the first path;
in real time, selectively determining a second path different from the first path based on the path efficiency at each of the plurality of periodic time steps, wherein the second path is determined when the path efficiency falls below a predetermined threshold value, and the second path terminates at a second location defined by a second of the one or more of the parking spots within a detection range of the optical sensing system; and
generating a first confidence value for the first path and generating a second confidence value for the second path, wherein the first and second confidence values increase as the vehicle moves closer to the second location along either the first path or the second path.

20. A system for calculating coordinates for localization of a vehicle, the system comprising:
a vehicle having a throttle system, a braking system, a transmission system, and a steering system; each of the throttle system, braking system, transmission system, and steering system providing directional control of the vehicle;
a control module disposed within the host vehicle and having a processor, a memory, and one or more input/output (I/O) ports; the I/O ports receiving input data from one or more sensors and actuators, and the I/O ports transmitting output data to one or more actuators of the vehicle; the processor executing programmatic control logic stored within the memory, the programmatic control logic comprising:
a first control logic continuously receiving optical data from an optical sensing system having one or more cameras;
a second control logic detecting one or more parking spots within the optical data;
a third control logic determining a first location of the vehicle relative to the one or more parking spots within the optical data, the first location of the vehicle defined by a predetermined set of physical vehicle parameters stored in memory and including a predetermined point location on the vehicle;
a fourth control logic utilizing the predetermined physical vehicle parameters to determine a range of possible first path trajectories;
a fifth control logic determining a subset of the one or more parking spots that the vehicle can reach based on the range of possible first path trajectories; and
a sixth control logic selecting one of the subset of the one or more parking spots as a second location;
a seventh control logic planning a first path from a first location to the second location different from the first location;
an eighth control logic engaging one or more vehicle positioning systems to move the vehicle from the first location to the second location;
a ninth control logic adjusting the first path in real time in response to the optical data as the vehicle moves between the first location and the second location; and
a tenth control logic engaging the one or more vehicle positioning systems to adjust movement of the vehicle along the first path once the first path has been adjusted.
